(19) United States
(12) Patent Application Publication
(10) Pub. No.: US 2012/0294288 A1
(43) Pub. Date: Nov. 22, 2012

(54) Apparatus and Method for Facilitating Dynamic Time Slot Allocation

(75) Inventors: Tom Chin, San Diego, CA (US); Guangming Shi, San Diego, CA (US); Kuo-Chun Lee, San Diego, CA (US)

(73) Assignee: QUALCOMM Incorporated, San Diego, CA (US)

(21) Appl. No.: 13/501,717

(22) PCT Filed: Mar. 31, 2010
(86) PCT No.: PCT/US10/29524

§ 371 Date: Jul. 23, 2012

Related U.S. Application Data
(60) Provisional application No. 61/260,714, filed on Nov. 12, 2009.

(51) Int. Cl. H04W 72/04

(52) U.S. Cl. 370/335

(57) ABSTRACT

A method and apparatus for facilitating dynamic time slot allocation is provided. The method may comprise receiving an assignment of at least one of a downlink time slot or an uplink time slot, wherein the downlink time slot is selected based on at least one of a number of used code channels in the downlink time slot, or a downlink transmit power, and wherein the uplink time slot is selected based on at least one of a number of used code channels in the uplink time slot, intra-cell interference, or other-cell interference.

### CROSS-REFERENCE TO RELATED APPLICATION(S)

This application claims the benefit of U.S. Provisional Patent Application No. 61/260,714, entitled “APPARATUS AND METHOD FOR FACILITATING DYNAMIC TIME SLOT ALLOCATIONS IN TD-SCDMA SYSTEMS,” filed on Nov. 12, 2009, which is expressly incorporated by reference herein in its entirety.

### BACKGROUND

1. Field

Aspects of the present disclosure relate generally to wireless communication systems, and more particularly, to facilitate dynamic time slot allocation in TD-SCDMA systems.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method includes receiving an assignment of at least one of a downlink time slot or an uplink time slot, wherein the downlink time slot is selected based on at least one of a number of used code channels in the downlink time slot, or a downlink transmit power, and wherein the uplink time slot is selected based on at least one of a number of used code channels in the uplink time slot, intra-cell interference, or other-cell interference.

In an aspect of the disclosure, an apparatus includes means for requesting an assignment from a network for at least one of a downlink time slot or an uplink time slot, and means for receiving an assignment of at least one of the downlink time slot or the uplink time slot, wherein the downlink time slot is selected based on at least one of a number of used code channels in the downlink time slot, or a downlink transmit power, and wherein the uplink time slot is selected based on at least one of a number of used code channels in the uplink time slot, intra-cell interference, or other-cell interference.

In an aspect of the disclosure, a computer program product includes a computer-readable medium which includes code for receiving an assignment of at least one of a downlink time slot or an uplink time slot, wherein the downlink time slot is selected based on at least one of a number of used code channels in the downlink time slot, or a downlink transmit power, and wherein the uplink time slot is selected based on at least one of a number of used code channels in the uplink time slot, intra-cell interference, or other-cell interference.

In an aspect of the disclosure, an apparatus includes at least one processor, and a memory coupled to the at least one processor. In such an aspect, the at least one processor may be configured to receive an assignment of at least one of a downlink time slot or an uplink time slot, wherein the downlink time slot is selected based on at least one of a number of used code channels in the downlink time slot, or a downlink transmit power, and wherein the uplink time slot is selected based on at least one of a number of used code channels in the uplink time slot, intra-cell interference, or other-cell interference.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a Node B in communication with a UE in a telecommunications system.

FIG. 4 is a functional block diagram conceptually illustrating example blocks executed to implement the functional characteristics of one aspect of the present disclosure.

FIG. 5 is another functional block diagram conceptually illustrating example blocks executed to implement the functional characteristics of one aspect of the present disclosure.

FIG. 6 is a block diagram conceptually illustrating a wireless system for facilitating dynamic time slot allocation according to an aspect.

FIG. 7 is a diagram conceptually illustrating exemplary downlink timeslot allocations according to an aspect.

FIG. 8 is a block diagram conceptually illustrating a graphical representation of a portion of a dynamic time slot allocation process according to an aspect.

FIG. 9 is a block diagram of an exemplary wireless communications device for facilitating dynamic time slot allocation according to an aspect.

FIG. 10 is an exemplary block diagram of a time slot allocation system according to an aspect.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

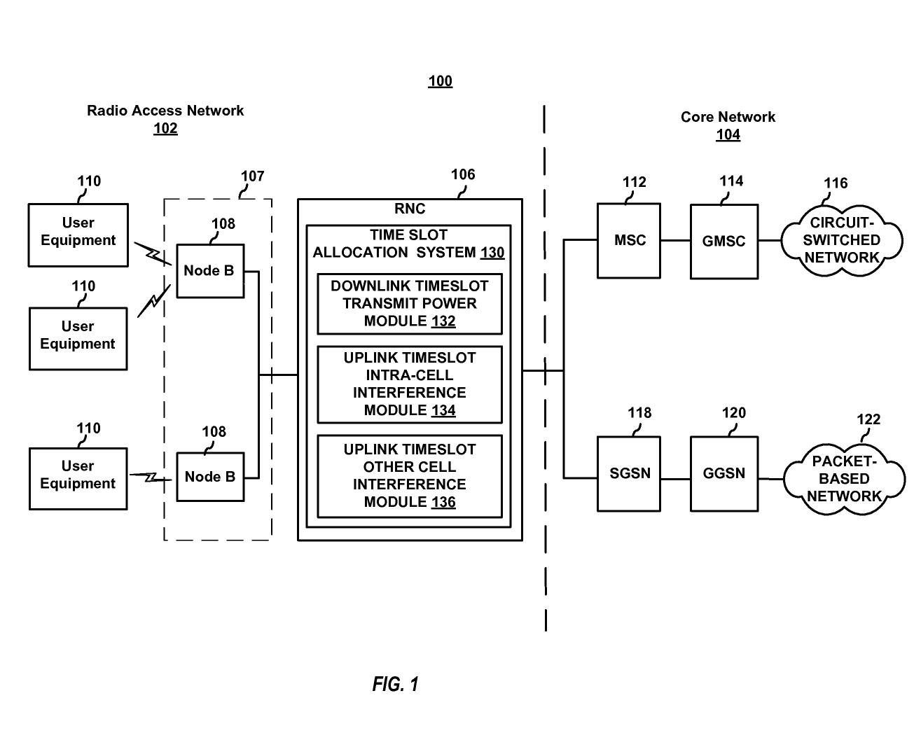

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108 are shown; however, the RNS 107 may include any number of wireless Node Bs. The Node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with at least one of the Node Bs 108. The downlink (DL), also called the forward link, refers to the communication link from a Node B to a UE, and the uplink (UL), also called the reverse link, refers to the communication link from a UE to a Node B.

Further, RAN 102 may include a time slot allocation system 130 which may be operable to monitor, coordinate and/or control the node Bs 108 with respect to a dynamic time slot allocation process. In one aspect, time slot allocation system 130 may be included within RNC 106, one or more servers, etc.

In one aspect, time slot allocation system 130 may further include downlink timeslot transmit power module 132, uplink timeslot intra-cell interference module 134, and uplink timeslot other cell interference module 136. In one such aspect of the system, downlink timeslot transmit power module 132 may be operable to determine the current transmit power in each downlink time slot (DL TS). This current transmit power value may be sampled instantaneously and/or averaged over time. In another aspect of the system, uplink timeslot intra-cell interference module 134 may be operable to determine intra cell interference for each uplink time slot (UL TS). This intra cell interference value may be measured and/or averaged over a time interval. Further, such averaging may be based on an exponential filtering function, or the like. In still another aspect, uplink timeslot other cell interference module 136 may be operable to determine other cell interference for each UL TS. This other cell interference value may be measured and/or averaged over a time interval. Further, such averaging may be based on an exponential filtering function, or the like.

In operation, time slot allocation system 130 may dynamically assign time slots to a requesting UE in a manner which is least costly, with respect to network resources. In other words, time slot allocation system 130 may analysis metrics associated with network, node B, etc., resources and may determine which time slots which, when assigned, provide the least, or a minimum stress on a networks available resources.

In an exemplary aspect, a set of indices for each DL TS per subframe (S_DL), and each UL TS per subframe (S_UL) may be generated. Thereafter, a dynamic time slot allocation process may obtain network performance related metrics to assist in allocating dedicated channel DPCH resource to a requesting UE, such as but not limited to the following metrics. A number of code channels (N_d(i)) being allocated in each DL TS in the indexed DL TS set. A number of code channels (N_u(j)) being allocated in each UL TS in the indexed UL TS set. A current transmit power (P_d(i)) for each DL TS in the indexed DL TS set. A total intra cell interference (Ior_u(j)) for each UL TS in the indexed UL TS set. An other cell interference (Ioc_u(j)) for each UL TS in the indexed UL TS set. Further, the number of code channels may be considered as a state variable, for example, if a UE requests to be allocated with 8 code channels, then two 16 code channels allotments may be counted as being allocated or used. Still further, as noted above, the states N_d(i), N_u(j) may be instantaneous states, as such, they can be sampled upon allocation of a TS. While, the states Ior_u(j) and Ioc_u(j) may be measured and averaged over some time interval. Such averaging may be based on the exponential filtering function. Further, the state P_d(i) may be sampled instantaneously and/or averaged over some time interval.

Continuing the above exemplary aspect, upon obtaining the above mentioned input state variables, the network may allocate code channel(s) to a UE to the dedicated channel requests on a particular DL TS(i) such that index i is the least costly (C_d) resource allocation as defined by equation (1) as follows:

C_{—}d=min{α1*N_{—}d(i)+β*P_{—}d(i)}, where iεS_{—}DL (1)

Further, the network may allocate code channel(s) to a UE to the dedicated channel requests on a particular UL TS(j) such that index j is the least costly (C_u) resource allocation as defined by equation (2) as follows:

C_{—}u=min{α2*N_{—}u(j)+γ1*Ior_{—}u(j)+γ2*Ioc_{—}u(j)}, where jεS_{—}UL (2)

The above referenced constants α1, α2, β, γ1 and γ2 may be weighting factors.

As such, above equation (1) may determine a DL TS(i) with minimal weighted sum of a number of used/allocated code channels and DL transmit power. Through use of equation (1), the system may weigh the code channel being used and DL transmit power in allocating new dedicated channel to the least loaded TS. Further, the above equation (2) may determine a UL TS(j) with minimal weighted sum of a number of used code channels and various UL interference power values. Through use of equation (2), the system may weigh the code channel being allocated and interference level. The interference at a node B may be measured with the intra-cell and other cell components which may have different effects on UL transmission performance, and as such, the influence of each of these two components may be accounted for separately.

In another exemplary aspect, time slot allocation system 130 may be operable in a multi-carrier system. In such a multi-carrier system, if the UE may transmit and receive using different carriers, independently, then the least costly TSs over the multiple carriers may be determined. For example, equations (1) and (2) may be extended to multiple carriers and the least costly TSs among all carriers may be selected. Additionally, or in the alternative, if the UE can only transmit and receive in the same carrier, then the least costly carrier, with respect to network resource usage, of the multiple carriers may be determined. In one exemplary aspect, time slot allocation system 130 may identify the least costly DL TS(i, k) and UL TS(j, k) for each carrier of a set of multiple carriers (kεS_f), with the associated minimum cost C_d(k) from (1) and C_u(k) in equations (1) and (2), respectively. Then a least costly carrier may be determined as defined by equation (3) as follows:

C=min{λ*C_{—}d(k)+(1−λ)*C_{—}u(k)}, where kεS_{—}f (3)

where λ is the weighting factor between DL and UL costs as determined in equations (1) and (2).

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

In one aspect, UE 110 can further include a dynamic timeslot assignment module that may facilitate requesting and receive timeslot assignments for the UE 110 allocated by time slot allocation system 130. In one aspect, the UE receives an assignment of at least one of a downlink time slot or an uplink time slot, wherein the downlink time slot is selected based on at least one of a number of used code channels in the downlink time slot, or a downlink transmit power, and wherein the uplink time slot is selected based on at least one of a number of used code channels in the uplink time slot, intra-cell interference, or other-cell interference.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 108 and a UE 110, but divides uplink and downlink transmissions into different time slots in the carrier.

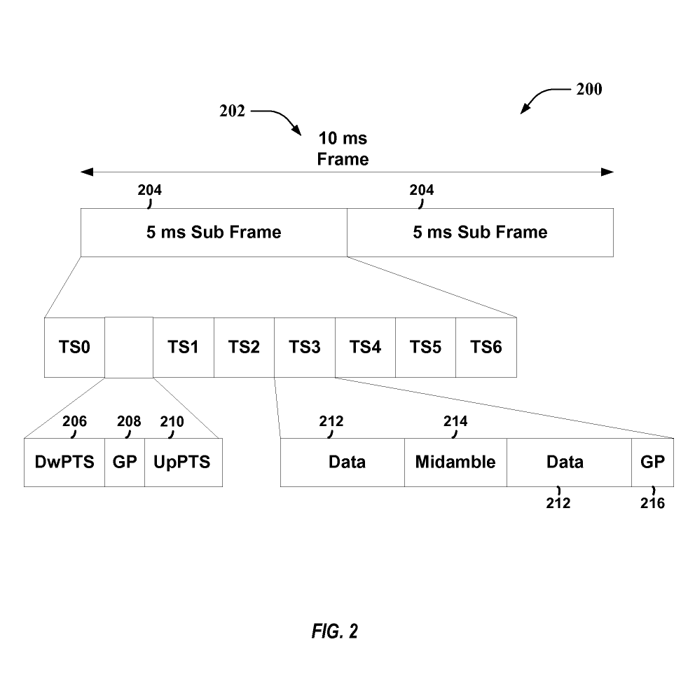

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots (TSs), TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a GP 216. The midamble 214 may be used for features, such as channel estimation, while the GP 216 may be used to avoid inter-burst interference. Further, there may be 16 code channels available for each TS. Using these code channels, a network may allocate time and code resources to shared or dedicated channels. For example, with dedicated channels, when the UE requests a new radio bearer (RB), the Node B may allocate specific code channels within DL/UL TS(s) to the UE. One common RB service is the 12.2 kbps circuit Switched (CS) RB that may allocate 2 code channels of one DL TS and 2 code channels of one UL TS repetitively for each subframe.

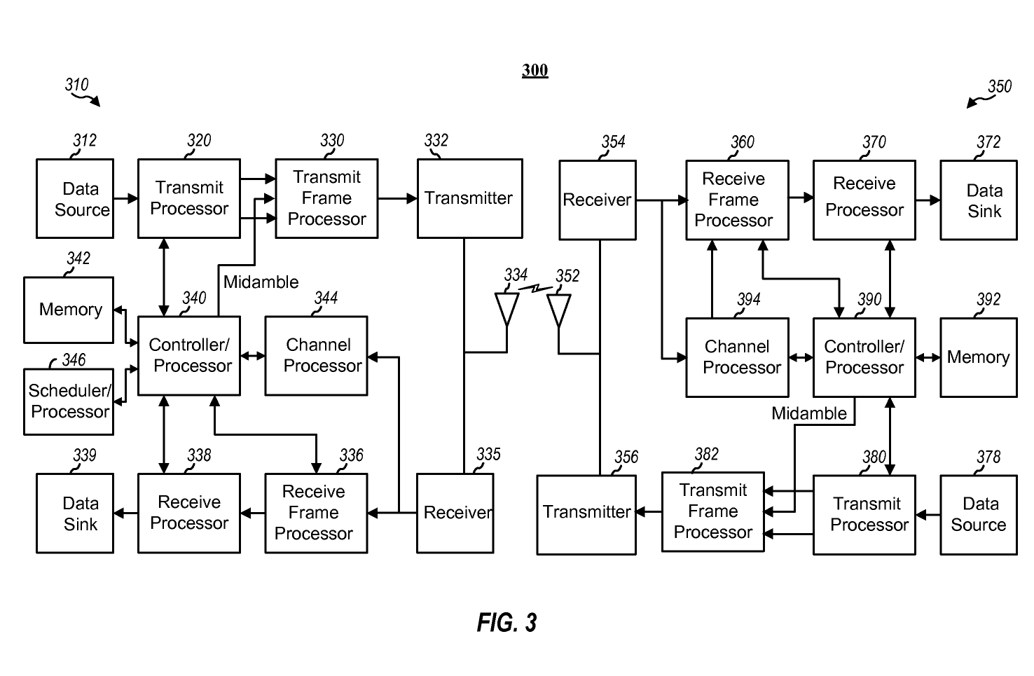

FIG. 3 is a block diagram of a Node B 310 in communication with a UE 350 in a RAN 300, where the RAN 300 may be the RAN 102 in FIG. 1, the Node B 310 may be the Node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an ACK and/or NACK protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the Node B 310 and the UE 350, respectively. A scheduler/processor 346 at the Node B 310 may be used to allocate resources to the UEs and schedule downlink and/or uplink transmissions for the UEs.

In one aspect, controller/processors 340 and 390 may facilitate establishing communications using a dynamic time slot allocation procedure. In one configuration, the apparatus 350 for wireless communication includes means for requesting an assignment from a network for at least one of a downlink time slot or an uplink time slot and means for receiving an assignment of at least one of the downlink time slot or the uplink time slot, wherein the downlink time slot is selected based on at least one of a number of used code channels in the downlink time slot, or a downlink transmit power, and wherein the uplink time slot is selected based on at least one of a number of used code channels in the uplink time slot, intra-cell interference, or other-cell interference. In one aspect, the aforementioned means may be the processor(s) 390 configured to perform the functions recited by the aforementioned means. In another aspect, the aforementioned means may be a module or any apparatus configured to perform the functions recited by the aforementioned means.

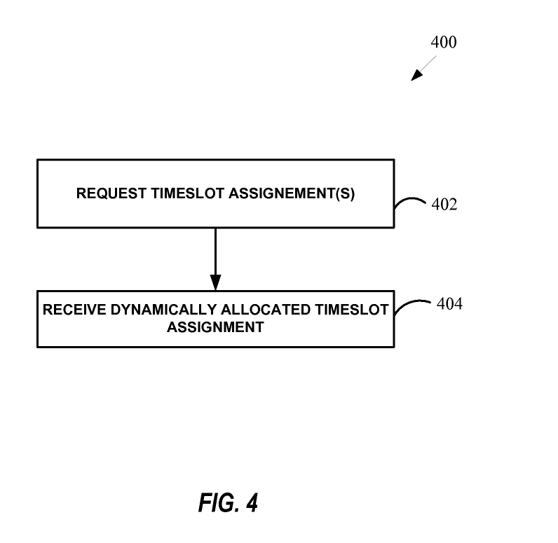

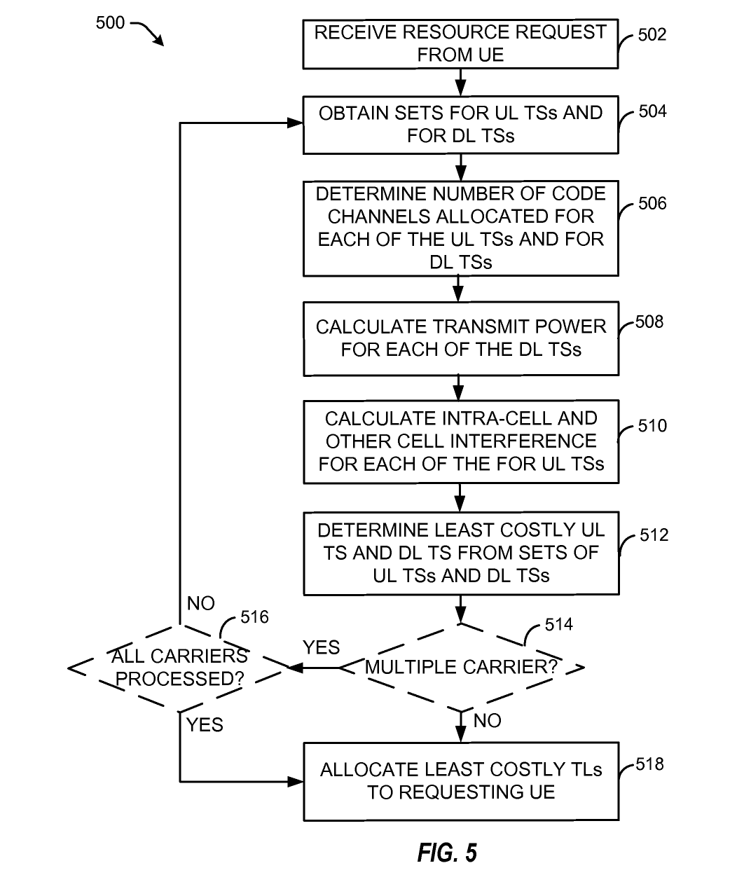

FIGS. 4 and 5 illustrate various methodologies in accordance with various aspects of the presented subject matter. While, for purposes of simplicity of explanation, the methodologies are shown and described as a series of acts or sequence steps, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 4 is a functional block diagram 400 illustrating example blocks executed in conducting wireless communication according to one aspect of the present disclosure. In block 402, a UE may transmit an access request to a network component. In one aspect, the network component may be a node B, an RNC, etc. In another aspect, the access request may be associated with an initial access procedure. In another aspect, the initial request may be associated with a hard handover procedure.

In block 404, dynamically allocated time slot assignments are received. In one aspect, the downlink time slot may be selected based on at least one of a number of used code channels in the downlink time slot, or a downlink transmit power, and the uplink time slot may be selected based on at least one of a number of used code channels in the uplink time slot, intra-cell interference, or other-cell interference. Further, in one aspect, the assignment for the downlink time slot may be selected based on a determination which downlink time slot is least costly of resources associated with a network. In such an aspect, the selection may include determining, by the network, a downlink time slot which results in a minimum value from a downlink time slot cost equation, wherein the downlink time slot cost equation includes adding the number of used code channels in the downlink time slot and the downlink transmit power for each downlink time slot. In another aspect, the assignment for the uplink time slot may be selected based on a determination of which uplink time slot is least costly of resources associated with a network. In such an aspect, the selection may including determining, by the network, an uplink time slot which results in a minimum value from an uplink time slot cost equation, wherein the uplink time slot cost equation includes adding the number of used code channels in the uplink time slot, the intra-cell interference, and the other-cell interference for each uplink time slot.

FIG. 5 is a functional block diagram 500 illustrating example blocks executed in conducting wireless communication according to one aspect of the present disclosure. In block 502, a network component, such as a node B, RNC, etc., may receive a resource request from a UE. In block 504, a set of indices for each DL TS per subframe (S_DL), and each UL TS per subframe (S_UL) may be obtained. In block 506, a number (N_d(i)) of spreading factors equal to 16 code channels, being allocated in each DL TS in the indexed DL TS set, and a number (N_u(j)) of spreading factors equal to 16 code channels, being allocated in each UL TS in the indexed UL TS set may be determined. In one aspect, the number of spreading factors (SF) may be considered as a state variable, for example, if a UE requests to be allocated with SF=8 code channels, then two SF=16 equivalent code channels may be counted as being allocated or used. Further in such an aspect, the number of spreading factors may be instantaneous states, that is, they can be sampled upon allocation of a TS. In block 508, a current transmit power (P_d(i)) for each DL TS in the indexed DL TS set may be calculated. In one aspect, the state P_d(i) may be sampled instantaneously and/or averaged over some time interval. In block 510, a total intra cell interference (Ior_u(j)) for each UL TS in the indexed UL TS set, and an other cell interference (Ioc_u(j)) for each UL TS in the indexed UL TS set may be calculated. In one aspect, the intra cell and other cell interference values may be measured and averaged over some time interval. Such averaging may be based on the exponential filtering function. In block 512, the least costly time slots for both the DL and UL are determined. In one aspect, such a determination is made through use of equations (1) and (2).

Optionally, in block 514, it may be determined whether the system is supported by multiple carriers. If in block 514, it is determined that there are not multiple carriers supporting the system, then in block 518, the least costly time slots may be allocated to the requesting UE. By contrast, if in block 514, it is determined there are multiple carriers, then in block 516, it is determined whether the described process has been performed for each of the multiple carriers. In one aspect, if the UE may transmit and receive using different carriers, independently, and as such equations (1) and (2) may be extended to multiple carriers and the least costly TSs among all carriers may be selected. Additionally, or in the alternative, if the UE can only transmit and receive in the same carrier, then further processing may be performed. In such an aspect, initially, the least costly DL TS(i, k) and UL TS(j, k) for each carrier of a set of carriers may be determined, with the associated minimum cost being C_d(k) from (1) and C_u(k) in equations (1) and (2), respectively. Then a least costly carrier may be determined as defined by equation (3) as noted above.

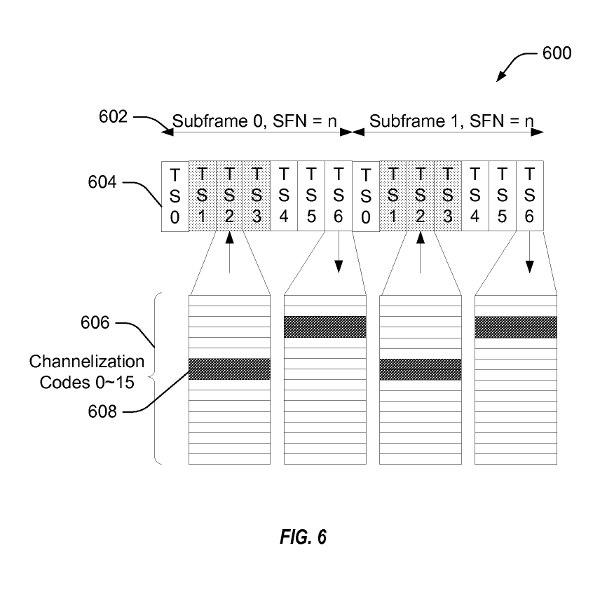

Turning now to FIG. 6, a block diagram conceptually illustrating a wireless system for facilitating dynamic time slot allocation in a system 600 is illustrated. In an exemplary time division synchronous code division multiple access (TD-SCDMA) system 600, a subframe 602 may include multiple timeslots 604, where some of the available time slots are allocated to uplink communications and some are allocated to downlink communications. Further, each timeslot may include multiple spreading factors (SF). In one such aspect, the multiple SFs may be associated with channelization codes, for example 16 channelization codes 606. During communications, channelization codes (e.g., code channels) may be assigned to communicate data 608. Using these channelization codes 606, a network may allocate time and code resource to shared or dedicated channels. For example, with dedicated channels, when a UE requests a new radio bearer (RB), a Node B may allocate some specific code channels in DL and UL TSs to the UE. For example, one common RB service is the 12.2 kbps circuit Switched (CS) RB that may be allocated using 2 code channels 608 of one DL TS and 2 code channels of one UL TS repetitively for each subframe.

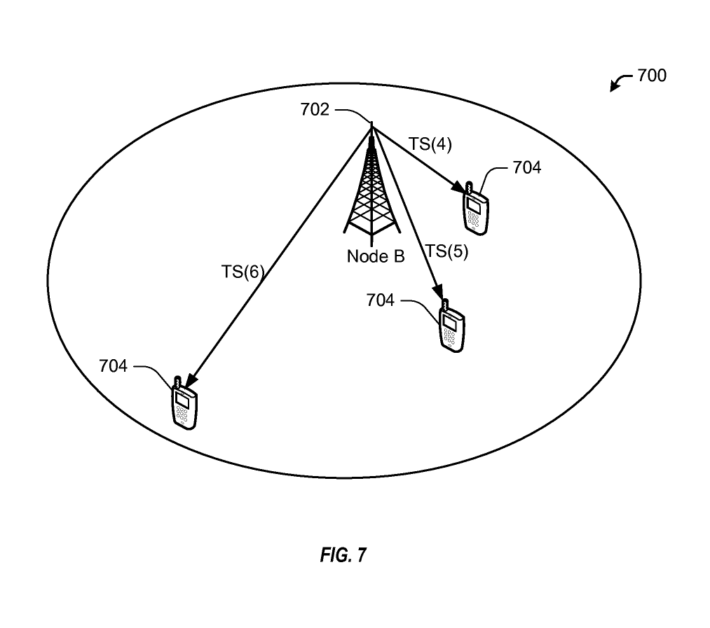

Turning now to FIG. 7, a diagram conceptually illustrating exemplary downlink timeslot allocations in a system 700 is illustrated. Generally, node B 702, may communicate with multiple UEs 704. As described above, in allocating DL TSs, transmit power may be considered. This may be because the node B 702 may be located at different location from the UEs 704, and as such, two dedicated channels for different UEs may use different transmit power. As depicted in FIG. 7, three UEs 704 have been assigned to use DL TS(4), DL TS(5), and DL TS(6). Assuming that the numbers of code channels used are the same between the various TSs, a new DPCH may be allocated to DL TS(4), since DL TS(6) serving the far-away UE uses more power.

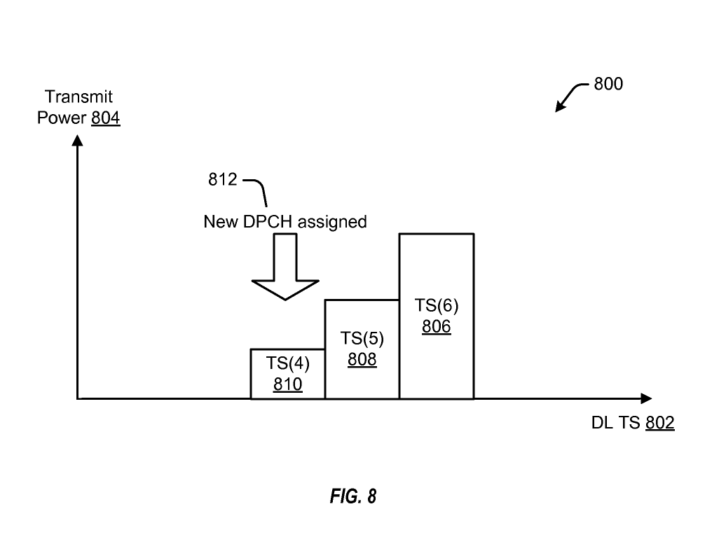

Turning now to FIG. 8, a block diagram conceptually illustrating a graphical representation of a portion of a dynamic time slot allocation process in a system 800 is illustrated. Generally, as part of a dynamic time slot allocation process, various metrics may be compared. For example, in determining which downlink time slot to assign, a network component may analyze downlink transmit power. As depicted with reference to FIG. 7, multiple UEs 704 may be located throughout a coverage region of a node B 702 and at difference distance from the node B 702. As such, a node B may use various DL transmit powers 804 for time slots 802 associated with different UEs. In such an aspect, a new DPCH assignment 812 may be assigned to the TS(4) 810 with a lower transmit power 804 than DL TSs 806 and 808.

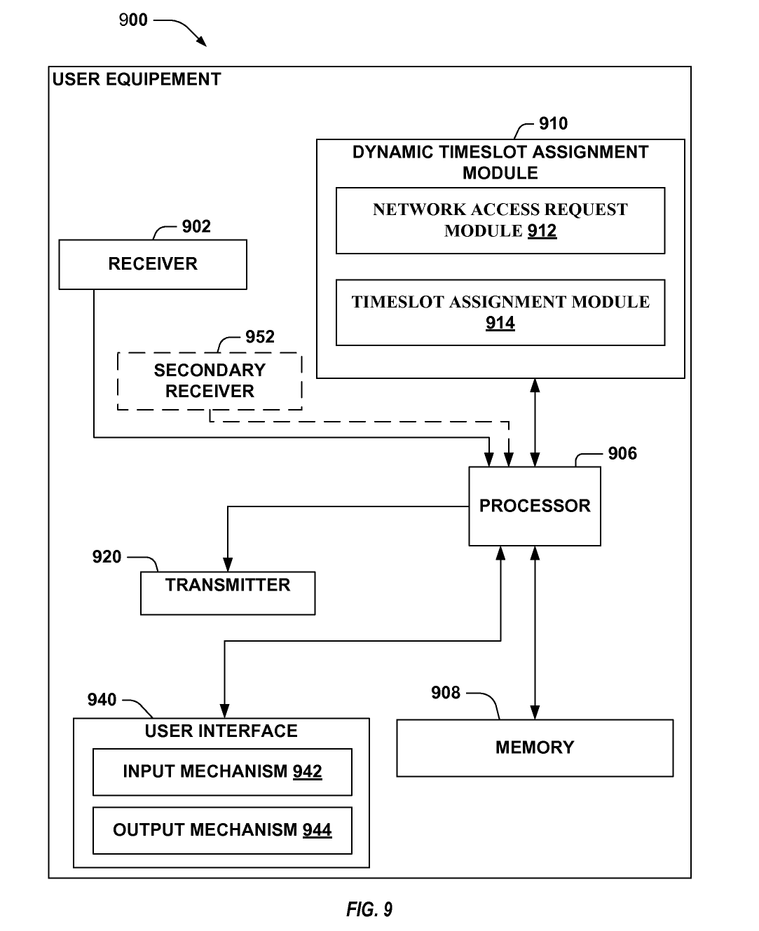

With reference now to FIG. 9, an illustration of a UE 900 (e.g., a client device, wireless communications device (WCD), etc.) that can facilitate dynamic time slot allocation is presented. UE 900 comprises receiver 902 that receives one or more signal from, for instance, one or more receive antennas (not shown), performs typical actions on (e.g., filters, amplifies, downconverts, etc.) the received signal, and digitizes the conditioned signal to obtain samples. Receiver 902 can further comprise an oscillator that can provide a carrier frequency for demodulation of the received signal and a demodulator that can demodulate received symbols and provide them to processor 906 for channel estimation. In one aspect, UE 900 may further comprise secondary receiver 952 and may receive additional channels of information.

Processor 906 can be a processor dedicated to analyzing information received by receiver 902 and/or generating information for transmission by one or more transmitters 920 (for ease of illustration, only one transmitter is shown), a processor that controls one or more components of UE 900, and/or a processor that both analyzes information received by receiver 902 and/or secondary receiver 952, generates information for transmission by transmitter 920 for transmission on one or more transmitting antennas (not shown), and controls one or more components of UE 900.

In one configuration, the UE 900 includes means for requesting an assignment from a network for at least one of a downlink time slot or an uplink time slot, and means for receiving an assignment of at least one of the downlink time slot or the uplink time slot, wherein the downlink time slot is selected based on at least one of a number of used code channels in the downlink time slot, or a downlink transmit power, and wherein the uplink time slot is selected based on at least one of a number of used code channels in the uplink time slot, intra-cell interference, or other-cell interference. In one aspect, the aforementioned means may be the processor 906 configured to perform the functions recited by the aforementioned means. In another aspect, the aforementioned means may be a module or any apparatus configured to perform the functions recited by the aforementioned means.

UE 900 can additionally comprise memory 908 that is operatively coupled to processor 906 and that can store data to be transmitted, received data, information related to available channels, data associated with analyzed signal and/or interference strength, information related to an assigned channel, power, rate, or the like, and any other suitable information for estimating a channel and communicating via the channel. Memory 908 can additionally store protocols and/or algorithms associated with estimating and/or utilizing a channel (e.g., performance based, capacity based, etc.).

It will be appreciated that the data store (e.g., memory 908) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory 908 of the subject systems and methods is intended to comprise, without being limited to, these and any other suitable types of memory.

UE 900 can further include dynamic time slot assignment module 910 that facilitate obtaining dynamically assigned time slots for the UE 900. In one aspect, dynamic time slot assignment module 910 may include network access request module 912, and time slot assignment module 914. Network access request module 912 may be operable to request an assignment from a network for at least one of a downlink time slot or an uplink time slot. In one aspect, a request may be made as part of an initial access procedure. In another aspect, a request may be made as part of a hard handover procedure.

Further, time slot assignment module 914, and may be operable to an assignment of at least one of a downlink time slot or an uplink time slot, wherein the downlink time slot is selected based on at least one of a number of used code channels in the downlink time slot, or a downlink transmit power, and wherein the uplink time slot is selected based on at least one of a number of used code channels in the uplink time slot, intra-cell interference, or other-cell interference. In one aspect, the assignment for the time slots may be selected based on a determination which downlink time slot is least costly of resources associated with a network.

Additionally, UE 900 may include user interface 940. User interface 940 may include input mechanisms 942 for generating inputs into UE 900, and output mechanism 944 for generating information for consumption by the user of wireless device 900. For example, input mechanism 942 may include a mechanism such as a key or keyboard, a mouse, a touch-screen display, a microphone, etc. Further, for example, output mechanism 944 may include a display, an audio speaker, a haptic feedback mechanism, a Personal Area Network (PAN) transceiver etc. In the illustrated aspects, output mechanism 944 may include a display operable to present content that is in image or video format or an audio speaker to present content that is in an audio format.

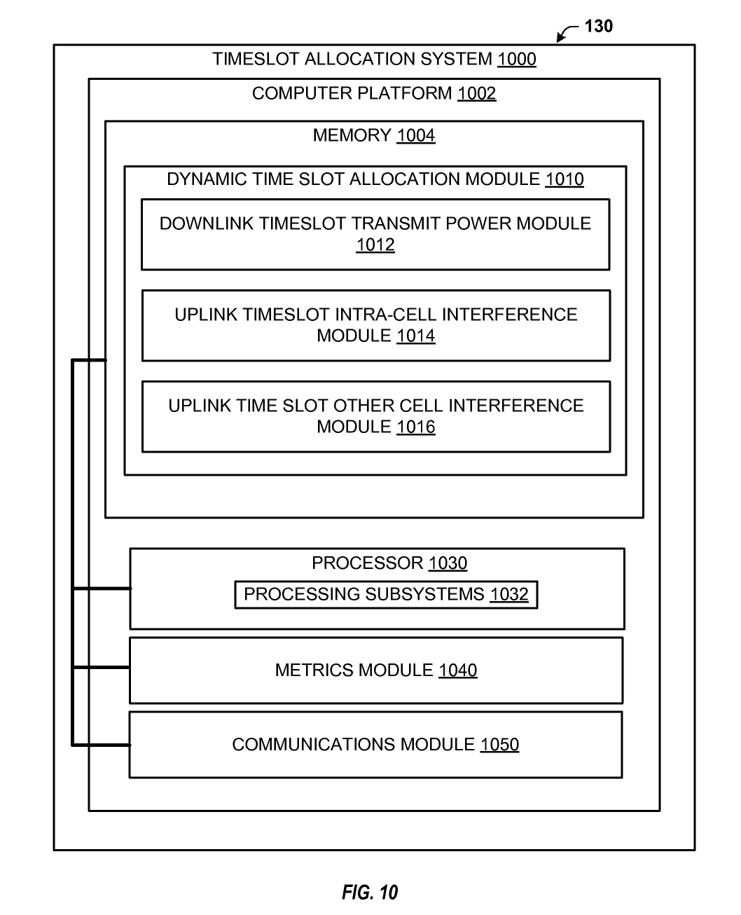

With reference to FIG. 10, illustrated is a detailed block diagram of time slot allocation system 1000, such as time slot allocation system 130 depicted in FIG. 1. Time slot allocation system 1000 may comprise at least one of any type of hardware, server, personal computer, mini computer, mainframe computer, or any computing device either special purpose or general computing device. Further, the modules and applications described herein as being operated on or executed by time slot allocation system 1000 may be executed entirely on a single network device, as shown in FIG. 10, or alternatively, in other aspects, separate servers, databases or computer devices may work in concert to provide data in usable formats to parties, and/or to provide a separate layer of control in the data flow between UEs 110, node Bs 108, and the modules and applications executed by time slot allocation system 1000.

Time slot allocation system 1000 includes computer platform 1002 that can transmit and receive data across wired and wireless networks, and that can execute routines and applications. Computer platform 1002 includes memory 1004, which may comprise volatile and nonvolatile memory such as ROM and RAM, EPROM, EEPROM, flash cards, or any memory common to computer platforms. Further, memory 1004 may include one or more flash memory cells, or may be any secondary or tertiary storage device, such as magnetic media, optical media, tape, or soft or hard disk. Still further, computer platform 1002 also includes processor 1030, which may be an application-specific integrated circuit (“ASIC”), or other chipset, logic circuit, or other data processing device. Processor 1030 may include various processing subsystems 1032 embodied in hardware, firmware, software, and combinations thereof, that enable the functionality of time slot allocation system module 1010 and the operability of the network device on a wired or wireless network.

Computer platform 1002 further includes communications module 1050 embodied in hardware, firmware, software, and combinations thereof that enables communications among the various components of time slot allocation system 1000, as well as between time slot allocation system 1000 and node Bs 108. Communication module 1050 may include the requisite hardware, firmware, software and/or combinations thereof for establishing a wireless communication connection. According to described aspects, communication module 1050 may include hardware, firmware and/or software to facilitate wireless broadcast, multicast and/or unicast communication of requested cell, Node B, UE, etc.

Computer platform 1002 further includes metrics module 1040, embodied in hardware, firmware, software, and combinations thereof, that enables metrics received from node Bs 108 corresponding to, among other things, data communicated from UEs 110. In one aspect, time slot allocation system 1000 may analyze data received through metrics module 1040 monitor network health, capacity, usage, etc. For example, if the metrics module 1040 returns data indicating that one or more of a plurality of node Bs are inefficient, then the time slot allocation system 1000 may not assign time slots associated with the inefficient node B(s).

Memory 1004 of time slot allocation system 1000 includes dynamic time slot allocation module 1010 operable for facilitating dynamic time slot allocation. In one aspect, dynamic time slot allocation module 1010 may include downlink timeslot transmit power module 1012, uplink timeslot intra-cell interference module 1014 and uplink time slot other cell interference module 1016. In one such aspect of the system, downlink timeslot transmit power module 1012 may be operable to determine the current transmit power in each DL TS. This current transmit power value may be sampled instantaneously and/or averaged over time. In another aspect of the system, uplink timeslot intra-cell interference module 1014 may be operable to determine intra cell interference for each UL TS. This intra cell interference value may be measured and/or averaged over a predetermined time interval. Further, such averaging may be based on an exponential filtering function, or the like. In still another aspect of the system, uplink timeslot other cell interference module 1016 may be operable to determine other cell interference for each UL TS. This other cell interference value may be measured and/or averaged over a predetermined time interval. Further, such averaging may be based on an exponential filtering function, or the like.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), RAM, ROM, PROM, EPROM, EEPROM, a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for wireless communication, comprising:
receiving an assignment of at least one of a downlink time slot or an uplink time slot, wherein the downlink time slot is selected based on at least one of a number of used code channels in the downlink time slot, or a downlink transmit power, and wherein the uplink time slot is selected based on at least one of a number of used code channels in the uplink time slot, intra-cell interference, or other-cell interference.

2. The method of claim 1, wherein the downlink time slot and the uplink time slot assignments are selected from a network including multiple carriers and multiple frequencies.

3. The method of claim 2, wherein the downlink time slot and the uplink time slot assignments are both selected from a single carrier of the multiple carriers.

4. The method of claim 1, further comprising:
requesting an assignment from a network for at least one of the downlink time slot or the uplink time slot, wherein the downlink transmit power either is determined when the request is received by the network or is determined as an average value of downlink transmit powers over a defined time interval.

5. The method of claim 4, wherein the downlink transmit power average value is derived by the network using an exponential scaling factor.

6. The method of claim 1, wherein the uplink intra-cell interference is determined as an average value of uplink intra-cell interference values measured by the network over a defined time interval.

7. The method of claim 6, wherein the uplink intra-cell interference average value is derived by the network using an exponential scaling factor.

8. The method of claim 1, wherein the uplink other-cell interference is determined as an average value of uplink other-cell interference values measured by the network over a defined time interval.

9. The method of claim 8, wherein the uplink other-cell interference average value is derived by the network using an exponential scaling factor.

10. The method of claim 1, wherein the assignment for the downlink time slot is selected based on a determination which downlink time slot is least costly of resources associated with a network.

11. The method of claim 10, wherein the determination which downlink time slot is least costly further comprises:
determining, by the network, a downlink time slot which results in a minimum value from a downlink time slot cost equation, wherein the downlink time slot cost equation includes adding the number of used code channels in the downlink time slot and the downlink transmit power for each downlink time slot.

12. The method of claim 1, wherein the assignment for the uplink time slot is selected based on a determination of which uplink time slot is least costly of resources associated with a network.

13. The method of claim 12, wherein the determination which uplink time slot is least costly further comprises:
determining, by the network, an uplink time slot which results in a minimum value from an uplink time slot cost equation, wherein the uplink time slot cost equation includes adding the number of used code channels in the uplink time slot, the intra-cell interference, and the other-cell interference for each uplink time slot.

14. The method of claim 1, wherein the wireless communication is operable in a time division synchronous code division multiple access (TD-SCDMA) system.

15. An apparatus for wireless communication, comprising:
means for requesting an assignment from a network for at least one of a downlink time slot or an uplink time slot; and
means for receiving an assignment of at least one of the downlink time slot or the uplink time slot, wherein the downlink time slot is selected based on at least one of a number of used code channels in the downlink time slot, or a downlink transmit power, and wherein the uplink time slot is selected based on at least one of a number of used code channels in the uplink time slot, intra-cell interference, or other-cell interference.

16. The apparatus of claim 15, wherein the downlink time slot and the uplink time slot assignments are selected from a network including multiple carriers and multiple frequencies.

17. The apparatus of claim 16, wherein the downlink time slot and the uplink time slot assignments are both selected from a single carrier of the multiple carriers.

18. The apparatus of claim 15, wherein the downlink transmit power either is determined when the request is received by the network or is determined as an average value of downlink transmit powers over a defined time interval.

19. The apparatus of claim 18, wherein the downlink transmit power average value is derived by the network using an exponential scaling factor.

20. The apparatus of claim 15, wherein the uplink intra-cell interference is determined as an average value of uplink intra-cell interference values measured by the network over a defined time interval.

21. The apparatus of claim 20, wherein the uplink intra-cell interference average value is derived by the network using an exponential scaling factor.

22. The apparatus of claim 15, wherein the uplink other-cell interference is determined as an average value of uplink other-cell interference values measured by the network over a defined time interval.

23. The apparatus of claim 22, wherein the uplink other-cell interference average value is derived by the network using an exponential scaling factor.

24. The apparatus of claim 15, wherein the assignment for the downlink time slot is selected based on a determination which downlink time slot is least costly of resources associated with a network.

25. The apparatus of claim 24, wherein the determination which downlink time slot is least costly further comprises:
means for determining, by the network, a downlink time slot which results in a minimum value from a downlink time slot cost equation, wherein the downlink time slot cost equation includes adding the number of used code channels in the downlink time slot and the downlink transmit power for each downlink time slot.

26. The apparatus of claim 15, wherein the assignment for the uplink time slot is selected based on a determination of which uplink time slot is least costly of resources associated with a network.

27. The apparatus of claim 26, wherein the determination which uplink time slot is least costly further comprises:
means for determining, by the network, an uplink time slot which results in a minimum value from an uplink time slot cost equation, wherein the uplink time slot cost equation includes adding the number of used code channels in the uplink time slot, the intra-cell interference, and the other-cell interference for each uplink time slot.

28. The apparatus of claim 15, wherein wireless communication is performed in a time division synchronous code division multiple access (TD-SCDMA) system.

29. A computer program product, comprising:
a computer-readable medium comprising code for:
receiving an assignment of at least one of a downlink time slot or an uplink time slot, wherein the downlink time slot is selected based on at least one of a number of used code channels in the downlink time slot, or a downlink transmit power, and wherein the uplink time slot is selected based on at least one of a number of used code channels in the uplink time slot, intra-cell interference, or other-cell interference.

30. The computer program product of claim 29, wherein the downlink time slot and the uplink time slot assignments are selected from a network including multiple carriers and multiple frequencies.

31. The computer program product of claim 30, wherein the downlink time slot and the uplink time slot assignments are both selected from a single carrier of the multiple carriers.

32. The computer program product of claim 29, wherein the computer-readable medium further comprises code for:
requesting an assignment from a network for at least one of the downlink time slot or the uplink time slot, wherein the downlink transmit power either is determined when the request is received by the network or is determined as an average value of downlink transmit powers over a defined time interval.

33. The computer program product of claim 32, wherein the downlink transmit power average value is derived by the network using an exponential scaling factor.

34. The computer program product of claim 29, wherein the uplink intra-cell interference is determined as an average value of uplink intra-cell interference values measured by the network over a defined time interval.

35. The computer program product of claim 34, wherein the uplink intra-cell interference average value is derived by the network using an exponential scaling factor.

36. The computer program product of claim 29, wherein the uplink other-cell interference is determined as an average value of uplink other-cell interference values measured by the network over a defined time interval.

37. The computer program product of claim 36, wherein the uplink other-cell interference average value is derived by the network using an exponential scaling factor.

38. The computer program product of claim 29, wherein the assignment for the downlink time slot is selected based on a determination which downlink time slot is least costly of resources associated with a network.

39. The computer program product of claim 38, wherein the determination which downlink time slot is least costly further comprises:
determining, by the network, a downlink time slot which results in a minimum value from a downlink time slot cost equation, wherein the downlink time slot cost equation includes adding the number of used code channels in the downlink time slot and the downlink transmit power for each downlink time slot.

40. The computer program product of claim 29, wherein the assignment for the uplink time slot is selected based on a determination of which uplink time slot is least costly of resources associated with a network.

41. The computer program product of claim 40, wherein the determination which uplink time slot is least costly further comprises:
determining, by the network, an uplink time slot which results in a minimum value from an uplink time slot cost equation, wherein the uplink time slot cost equation includes adding the number of used code channels in the uplink time slot, the intra-cell interference, and the other-cell interference for each uplink time slot.

42. The computer program product of claim 29, wherein the computer program product is operable in a time division synchronous code division multiple access (TD-SCDMA) system.

43. An apparatus for wireless communication, comprising:
at least one processor; and
a memory coupled to the at least one processor,
wherein the at least one processor is configured to:
receive an assignment of at least one of a downlink time slot or an uplink time slot, wherein the downlink time slot is selected based on at least one of a number of used code channels in the downlink time slot, or a downlink transmit power, and wherein the uplink time slot is selected based on at least one of a number of used code channels in the uplink time slot, intra-cell interference, or other-cell interference.

44. The apparatus of claim 43, wherein the downlink time slot and the uplink time slot assignments are selected from a network including multiple carriers and multiple frequencies.

45. The apparatus of claim 44, wherein the at least one processor is further configured to:
request an assignment from a network for at least one of the downlink time slot or the uplink time slot, wherein the downlink transmit power either is determined when the request is received by the network or is determined as an average value of downlink transmit powers over a defined time interval.

46. The apparatus of claim 43, wherein the downlink transmit power average value is derived by the network using an exponential scaling factor.

47. The apparatus of claim 43, wherein the uplink intra-cell interference is determined as an average value of uplink intra-cell interference values measured by the network over a defined time interval.

48. The apparatus of claim 47, wherein the uplink intra-cell interference average value is derived by the network using an exponential scaling factor.

49. The apparatus of claim 43, wherein the uplink other-cell interference is determined as an average value of uplink other-cell interference values measured by the network over a defined time interval.

50. The apparatus of claim 49, wherein the uplink other-cell interference average value is derived by the network using an exponential scaling factor.

51. The apparatus of claim 43, wherein the assignment for the downlink time slot is selected based on a determination which downlink time slot is least costly of resources associated with a network.

52. The apparatus of claim 51, wherein the determination which downlink time slot is least costly further comprises:
determining, by the network, a downlink time slot which results in a minimum value from a downlink time slot cost equation, wherein the downlink time slot cost equation includes adding the number of used code channels in the downlink time slot and the downlink transmit power for each downlink time slot.

53. The apparatus of claim 43, wherein the assignment for the uplink time slot is selected based on a determination of which uplink time slot is least costly of resources associated with a network.

54. The apparatus of claim 53, wherein the determination which uplink time slot is least costly further comprises:
determining, by the network, an uplink time slot which results in a minimum value from an uplink time slot cost equation, wherein the uplink time slot cost equation includes adding the number of used code channels in the uplink time slot, the intra-cell interference, and the other-cell interference for each uplink time slot.

55. The apparatus of claim 43, wherein the wireless communication is performed in a time division synchronous code division multiple access (TD-SCDMA) system.
